(19) United States
(12) Patent Application Publication
(10) Pub. No.: US 2024/0351787 A1
(43) Pub. Date: Oct. 24, 2024

(54) Transporting Mined Material

(71) Applicant: Technological Resources Pty. Limited, Melbourne (AU)

(72) Inventor: Florian Andreas OPPOLZER, Melbourne (AU)

(21) Appl. No.: 18/685,943

(22) PCT Filed: Aug. 25, 2022
(86) PCT No.: PCT/AU2022/051026

§ 371 Date: Feb. 23, 2024

(30) Foreign Application Priority Data
Aug. 25, 2021 (AU) 2021221760
Aug. 25, 2021 (AU) 2021221812
Aug. 25, 2021 (AU) 2021221826
Aug. 25, 2021 (AU) 2021221840

(51) Int. Cl. B65G 1/137; B65G 1/04; B65G 63/00; G06Q 10/087

(52) U.S. Cl. CPC B65G 1/1371; B65G 63/008; G06Q 10/087; B65G 1/0457; B65G 1/0492; B65G 2201/0235; B65G 2203/0216

(57) ABSTRACT

Mined material is transported within and outside a mine (10) in containers (26) that are fixed. discrete load units. namely containers that define a fixed maximum volume that can be carried in each container. The containers can be carried on or coupled to and then removed from vehicles (16) or other transport options. such as flatbed trucks. flatbed rail carriages or overhead suspension units. The containers can be stored at designated container storage facilities (28) in the mine. The container storage facilities are holding areas for loaded containers at mines until decisions are made to transport the containers to mineral processing plants (30) in the mine or to end-use customers. for example via rail to a shipping port (24).

### TECHNICAL FIELD

The invention relates to transporting a mined material within a mine.

The invention relates to transporting a processed mined material within a mine.

The invention also relates to transporting a mined material and a processed mined material from a mine.

The invention relates to surface, such as open-cut, mines and underground mines.

The invention also relates to a container for receiving a mined material and a processed mined material to be transported within a mine and/or from a mine.

The invention also relates to a “movable unit” configured to transport a container for a mined material and a processed mined material within a mine and/or from a mine.

The invention also relates to a “moving unit” configured to transport a container for a mined material and a processed mined material within a mine and/or from a mine.

The invention also relates to a mine that includes a “stockpile” for a mined material that includes a storage facility for containers of the mined material.

The invention also relates to a mine that includes a “stockpile” for a processed mined material that includes a storage facility for containers of the processed mined material.

### BACKGROUND ART

The transportation of material within a mine and from a mine typically involves transporting different-sized loads (a) within different sections of a mine, (b) from a mine to a shipping port, and (c) at a shipping location (i.e. a customer plant), often with off-loading of loads from a transportation option onto stockpiles and loading stockpiled material onto the same or other transportation options.

In this context, the term “material” includes mined material and processed material.

The term “mined material” is defined further below.

The term “processed mined material” includes mined material that has been processed to an extent, for example by being sorted on the basis of size or the concentration of an element, whether the processing be wet or dry processing of material.

There are many different transportation options for mined material and processed mined material that are used in the mining industry.

For example, a mined material is typically moved and transported within a mine and from a mine in excavator buckets, trays of rear-tipping haul trucks and conveyors. The buckets, trays and conveyors are ideally filled as close as possible to its maximum capacity. However, load volumes vary considerably within and across the range of transportation options.

Conventional transportation options include a range of vehicles and conveyors.

Conventional vehicles for moving mined material include large haul trucks with rear-tipping trays, dozers excavators, rope shovels, face shovels for open cut mines, load, haul, dump (LHD) vehicles for underground mines, rail cars for transporting mined material from mines to shipping terminals, such as ports.

It is also known to transport mined material via conveyors, for example via in-pit crushing and conveying (IPCC) systems. Conveyors are also used in open cut mines, underground mines, and at shipping terminals.

An article by Andrew Topf dated 16 Feb. 2017 published in Mining[Dot] Com, that is focused primarily on in-pit crushing and conveying systems, describes well the challenges facing mining companies in relation to transporting mined material within mines and from mines. The article describes that transporting ore and waste rock is one of the most crucial elements in surface mining pits and can be over 50% of the total operating cost of mines. The article also describes that transportation options for surface mining have moved from a preference for trains up to the 1960s to increasingly larger haul trucks now. The article also describes that climate change concerns have resulted in increasing emphasis of reducing emissions from haul trucks and greater emphasis on monitoring performance and scheduling maintenance to optimise performance (and minimise emissions). The article also describes that, despite advantages in many areas, there are issues with large haul trucks, including capital and operating/maintenance costs of the trucks, capital and operating/maintenance costs for roadways, and the need for very skilled drivers.

The article focuses on surface mines. Similar comments apply to underground mines, where diesel-powered load, haul, dump (LHD) vehicles and conveyors are transport options for moving mined material in mines.

In this context, “mined material” is understood to include as-mined material and may include as-mined material that has been at least primary crushed in open cut and underground mines. The term “mined material” includes material that is in a mine pit as a result of drilling and blasting in an open cut mine and material produced as a continuous miner moves over a mine floor and digs material from the floor in an open cut mine. The term “mined material” includes material mined in underground mines, such as from block cave mines or by longwall miners, etc.

Mined material is typically transported from an area being mined, whether that be an open-cut or underground mine, for processing within the mine. Processing options include size separation plants and processing in mineral processing plants that upgrade the material for example via comminution and mineral recovery units. The mined material is often stored in stockpiles before being processed such as in mineral processing plants. Mined material is often transported with minimal processing (for example, size separation only) from a mine to a transport terminal, such as a shipping port. Typically, mined material is stored in stockpiles at shipping ports, particularly in the case of iron ore that may need to be blended to meet customer specifications. Mined material that is low grade (i.e. has a concentration of a selected element, whether that is measured directly or indirectly, below a selected concentration form the viewpoint of having sufficient economic value at that time) is often stored in stockpiles with a view to reclaiming the mined material at a future date when the mined material is regarded as having economic value and therefore being marketable.

In this context, the term “mine” is understood herein to include an area that is being mined in an open cut mine or an underground mine and stockpiles and size separation plants and mineral processing plants (including for example comminution units and mineral recovery units associated with the mine).

There are issues storing mined material and processed mined material in stockpiles. These issues include loss of material in the process of transporting mined material and processed mined material to stockpiles and then from stockpiles and loss of material in the stockpiles due to wind and other environmental factors. These issues also include dilution of material due to mixing and material flow and hence loss of accurate information on material properties.

The invention provides an alternative to conventional vehicles and conventional conveyor systems for moving mined material and processed mined material within mines and from mines.

The invention also provides an alternative to conventional stockpiling of mined material and processed mined material.

The above description is not an admission of the common general knowledge in Australia or elsewhere.

### SUMMARY OF THE DISCLOSURE

In general terms, the invention transports mined material within and outside a mine in containers that are fixed, discrete load units, namely containers that define a fixed maximum volume that can be carried in each container, and can be carried on or coupled to and then removed from vehicles or other transport options, such as flatbed trucks, flatbed rail carriages or overhead suspension units, and can be stored at designated container storage facilities in the mine. The container storage facilities are holding areas for loaded containers at mines until decisions are made to transport the containers to mineral processing plants in the mine or to end-use customers, for example via rail to a shipping port and then on ships to customers.

One aspect of the invention is a method of mining in a mine that includes:
(a) mining an area in the mine;
(b) loading a mined material in the mining area into a container that is or can be demountably located on a movable unit or is or can be demountably coupled to a moving unit;
(c) transporting the loaded container from the mining area on the movable unit or the moving unit to a container storage facility in the mine or a mineral processing plant in the mine; and
(d) removing the loaded container from the movable unit or the moving unit in the container storage facility and storing the loaded container in the facility; or
(e) removing the loaded container from the movable unit or the moving unit at the mineral processing plant and processing the material in the plant.

The term “container” is understood herein to mean any container with mechanical properties that are suitable to withstand loading, handling and transporting mined material within a mine or from a mine.

One example of a container is an intermodal, such as a shipping container-sized, unit which is configured to be top-filled.

The term “moving unit” should be read as a noun. In other words, the term “moving” in the term “moving unit” is not to be read as a verb. The “moving unit” can be either be moving or stationary depending on its use.

A “movable unit” is a unit that is not limited to movement along a particular path. On the other hand, a “moving unit” is a unit that is limited to movement along a particular path, as defined by rails or guides.

The “movable unit” and the “moving unit” may be any suitable units.

By way of example, the “movable unit” may be an autonomous, movable vehicle that is configured, for example by having a flatbed tray, to receive and support the container while the container holds material.

By way of example, the moving unit may be an overhead suspension unit, such as a ski-lift type unit, that is configured to support and transport the container along a pathway between a loading location and an unloading location.

The container storage facility may be an engineered stockpile for storing mined material or processed mined material in a mine, the stockpile comprising a plurality of containers each containing a volume of mined material or processed mined material and a tracking identifier for each container, the tracking identifier associated with a digital record identifying a location of the container and optionally one or more properties of the material in the container.

The method covers at least the following four scenarios.
1. A container is on the ground in a mine pit and loaded with the mined material and is then lifted onto a “movable unit” such as a flatbed truck.
2. As per 1 but, after being loaded while on the ground, the loaded container is then lifted onto a “moving unit”.
3. A container is on a “movable unit” and is loaded with mined material.
4. A container is on a “moving unit” and is loaded with mined material.

The method may include loading the stored loaded container at the storage facility onto a movable unit or a moving unit and transporting the loaded container to (i) the mineral processing plant and discharging the material from the container at the plant and processing the material in the plant or (ii) a railhead or other transport terminal and transferring the container from the “movable unit” or the “moving unit” onto flatbed rail carriages and transporting the containers to another location, such as a port.

The method may include transporting the loaded container on the “movable unit” or the “moving unit” from the mining area to a mineral processing plant and discharging the mined material from the loaded container at the plant and processing the material in the plant. The method may include tracking the location of the container.

The method may include tracking movement of the container within and from the mine and at downstream locations such as a shipping terminal or a customer location.

The method may include recording one or more properties of the material in the container.

The one or more properties may include a grade of the mined material, a mineralogy of the mined material such as an average particle size or a chemical composition of the mined material in the container.

Another aspect of the invention is a method of mining in a mine that includes:
(a) loading a mined material in a mine into a container that is or can be demountably located on a “movable unit” or is or can be demountably coupled to a “moving unit”; and
(b) transporting the container on the “movable unit” or the “moving unit” to a storage facility for containers and removing the container from the “movable unit” or the “moving unit” and storing the container at the facility.

The mined material may be as-mined material or material in a stockpile in the mine.

Another aspect of the invention is a method of mining in a mine that includes:
(a) loading a mined material in a mine into a container that is or can be demountably located on a “movable unit” or is or can be demountably coupled to a “moving unit”; and
(b) transporting the container on the “movable unit” or the “moving unit” to a mineral processing plant and discharging the mined material from the container at the plant and processing the material in the plant.

The mined material may be as-mined material or material in a stockpile in the mine.

Another aspect of the invention is a container storage facility in the form of an engineered stockpile for storing mined material or processed mined material in a mine, the stockpile comprising a plurality of containers each containing a volume of mined material or processed mined material and a tracking identifier for each container, the tracking identifier associated with a digital record identifying a location of the container.

The digital record may include one or more properties of the material in the container.

The stockpile may comprise a retrieval system for identifying where in the stockpile a specified container is located and retrieving the specified container from its location.

Each of the plurality of containers may be a uniform size and be adapted for removable mounting and dismounting on/from a movable unit or moving unit.

The containers may be different sizes.

The size or form (i.e. shape) of each of the plurality of containers may conform to a predetermined international or industry standard.

The containers are described further below.

The one or more properties may include a grade of the mined material, a mineralogy of the mined material such as an average particle size or a chemical composition of the mined material in the container.

The containers may include container identification, including by way of example, data on the minerology and mass of a payload in the container at a given point in time.

The container identification may include QR codes indicative of mineralogy, such as grade, quality (e.g. penalty elements, deleterious material, etc.).

Another aspect of the invention is a mine that includes:
(a) an area to be mined or being mined in the mine; and
(b) a storage facility for containers of mined material transported from the mine area, the containers being configured to be demountably located on a “movable unit” or demountably coupled to a “moving unit”.

The container storage facility may be configured, by way of example, to be operated along the same lines as a container ship harbour facility (e.g. using automated straddle carriers, gantries, etc.).

An advantage of having a storage facility for containers of mined material located at the mine is that it negates the requirement for open stockpiles and their disadvantages.

Open stockpiles are open to the elements and therefore subject to material loss and dilution. Closed containers avoid such material loss and dilution due to the elements.

Conventionally, trucks are loaded from the open stock pile using excavator shovels. The volume of material and size of rocks contained in each shovel fluctuates between loads, also known as a variable fill factor, which results in unpredictable and irregular loading of trucks. Irregular loading of trucks contributes to reliability and maintenance issues with the trucks. As such, a stockpile of containers containing discrete loads improve the predictability and regularity of loading and consequently contribute to an improvement in fleet reliability and maintenance of trucks used to carry such containers.

By way of example, the container storage facility may include “carrier units” for moving and locating containers in selected locations and for retrieving the containers from the locations, when required.

The “carrier units” may be gantry cranes or any other suitable carrier options.

In addition, the container storage facility may include a container tracking system to identify the location of each container, optionally with data on the mineralogy, including physical properties (such as particle size distribution) and chemical composition, of the mined material in each container. As described below, the tracking system may be part of a more extensive mine-to-customer tracking system for mined (and processed) material.

The mineralogy data may be obtained from analysis of material to be mined before the material is mined.

The mineralogy data may be also or alternatively be obtained from analysis of material in a mine pit, for example via in-pit sensors and analysis of sensed data.

The mine may also include an empty container storage facility that stores a plurality of empty containers and is configured to load the containers onto a “movable vehicle”.

The empty container storage facility may be configured to be operated along the same lines as a container ship harbour facility (e.g. using automated straddle carriers, gantries, etc.).

The mine may include a container tracking system for tracking movement of containers within and from the mine and at downstream locations such as a shipping terminal or a customer location.

The container tracking system may be a mine-to-shipping port tracking system for mined (or processed) material.

The container tracking system may be a mine-to-customer tracking system for mined (or processed) material.

The container tracking system may be configured to track the location of a container in the container storage facility.

The container tracking system may be configured to record the location and movement of each container.

The container tracking system may be configured to record the load (mass) and properties (mineralogy) of each container.

The container tracking system may include a data storage unit to store the movement history of each container within and from a mine, including, for example movement history in a shipping terminal or a customer location).

The container tracking system may use any suitable technologies such as blockchain and RFID.

The mine may include a mine planning and scheduling system that is responsive to information in the container tracking system, operating capabilities and availability of equipment (such as crushers, etc) in the mine, transportation scheduling within and from the mine (including taking into account the status of operations in other linked mines, if any), customer requirements for mineralogy of mined (or processed) material, and scheduling and processing equipment capability/availability in a port or other product shipping terminal. The tracking information may be used to make automated decisions on feed material for a crusher or in which order to process material in a stockpile.

The mine planning and scheduling system may be configured to adjust operations within the mine or in transporting material from the mine or at a port or other shipping terminal having regard to the above-mentioned factors to optimise production and shipping to customers.

The mine planning and scheduling system may be an operator-controlled “menu” system which includes a menu of available containers holding material, each with information on the amount and mineralogy of the material, and the container location, from which an operator can browse and select a particular container or series of containers for processing and delivery to meet a customer order.

The container may include container identification, including by way of example, data on the minerology and mass of a payload in the container at a given point in time. The container identification may include QR codes indicative of mineralogy, such as grade, quality (e.g. penalty elements, deleterious material, etc.).

As noted above, the “movable unit” may be an autonomous, movable vehicle that is configured to receive and support the container while the container holds the payload of material.

The “movable unit” may be any one or more of autonomously-operated, manually-operated, or semi-autonomously operated.

The “movable unit” may be a wheel-mounted or track-mounted or rail-mounted or any other suitable vehicle that can move along a pathway, such as a road or a track or a railway track.

The “movable unit” may be configured to mount the container on the unit.

The “movable unit” may include any suitable container mounting, i.e. locating, member. A flatbed tray is one possible example of a mounting member.

The “movable unit” may include an element to releasably retain, i.e. secure, the container to the container support member and consequently to the “movable unit”. The retaining element may be in the form of locking elements or any other suitable elements.

The “movable unit” may be an electric powered unit.

The “movable unit” may be powered by any other suitable energy source.

One particular “movable unit” of interest to the applicant is a so-called Right Sized Autonomous Truck (“RSAT”).

The term “RSAT” as described herein means a conventionally-sized, autonomous, and preferably although not exclusively electric, movable vehicle, such as a truck, that is configured to receive and support a container holding mined material.

The term “conventionally-sized” as used herein describes trucks that are around or within the conventional size range of “movable vehicles”, such as trucks, that can travel on public roads.

The opportunity to use conventionally-sized vehicles is in contrast to existing mine haulage trucks typically described as “Ultra-class” trucks, i.e. rigid dump trucks specifically engineered for use in high-production mining and heavy-duty construction environment, capable of carrying payloads of at least 150 tonnes. “Ultra-class” trucks are very expensive vehicles and require substantial investment in roadways and maintenance of roadways.

As such, the use of RSATs and other conventionally-sized vehicles in the context of a mine can assist in realising the following advantages:

Firstly, roads and ramps may be used in and around the mine which are narrower and steeper than the roadways suitable for “Ultra-class” trucks. Narrow and/or steep roads and ramps require less time to develop as less ground (e.g. overburden) needs to be excavated in the development process. This leads to an increase in the strip ratio of the mine because less overburden is required to be excavated to produce the roads. Roads and ramps can be sealed and are therefore easier to maintain. Sealed roads and ramps result in fewer dust and air borne particulate matter that might otherwise need to be suppressed. Sealed roads and ramps also provide a smoother ride which may contribute to extending the interval between necessary vehicle maintenance and improvement in vehicle safety. Sealed roads and ramps also allow for increased maximum speeds and hence reduced haulage cycle times.

Secondly, RSATs and other conventionally-sized vehicles are an opportunity to mine comparatively small volumes of valuable minerals that would otherwise be uneconomical to mine with “Ultra-class” trucks and associated large scale excavators.

Thirdly, RSATs and other conventionally-sized vehicles are typically cheaper to purchase, operate and maintain than “Ultra-class” trucks, even though more vehicles are required to transport the same payload. They require less specialised engineering skills to maintain the vehicles compared to “Ultra-class” trucks. RSATs have an improved range over “Ultra-class” trucks which leads to a reduction in double handling, i.e. rehandling of material. More particularly, typically, “Ultra-class trucks” have a limited travel range when loaded and can only travel a short distance from the mine before dumping their load in an open pile-the dumped load is then reloaded onto other trucks to be transported further from the mine.

Fourthly, some RSATs and other conventionally-sized vehicles have a chassis size that makes them suitable to carry standard intermodal type containers, i.e. 20 ft or 40 ft shipping containers. Some of the many advantages of these types of containers are elaborated on further in this specification.

Another aspect of the invention is a “movable unit” that is configured to carry the above-described container within a mine or from a mine.

The “movable unit” may be the above mentioned movable vehicle, such as the above-mentioned wheel-mounted or track-mounted or rail-mounted vehicle that can move along a pathway, such as a road or a railway track.

Another aspect of the invention is a “moving unit” that is configured to carry the above-described container within a mine or from a mine.

The “moving unit” may be the above-mentioned overhead suspension unit.

Another aspect of the invention is a container, such as a top-filling container, that can be (a) carried on and removed from a “movable unit” or (b) coupled to and removed from a “moving unit” for transporting mined material or a processed mined material within a mine or from a mine, for example to a shipping terminal or a customer location spaced away from the mine.

The use of a container for a mined material and processed mined material of the invention that can be picked up and placed on a “movable unit” or coupled to a “moving unit” and transported on the unit between locations and then removed from the unit with a payload of material in the unit is a departure from the conventional use of haul trucks and LHDs in open cut and underground mines in which the movable unit and the storage tray for mined material are in a single integrated unit.

The use of the container of the invention also provides an opportunity to stockpile mined material or a processed mined material in the containers in an intermodal, such a shipping port-like, storage and handling facility. This increases the options for mining operation schedulers in meeting customer orders.

Basically, the use of the container of the invention provides an opportunity to decouple the volume of material being transported within a mine and from a mine from the selection of the transportation options for carrying the material. The container provides an opportunity to transport a “unit” payload within and from a mine in the container. This is a significant shift from the approach of conventional mining. The use of the container means that the “unit” payload is defined (and definable) even before it is transported, and it can continue to be defined (or definable) while in the container as it is transported within and from the mine and at a shipping terminal.

As noted above, the term “container” is understood herein to mean any container with mechanical properties that are suitable to withstand loading, handling and transporting mined material within a mine or from a mine.

One example of a container is an intermodal, such as a shipping container-sized, unit which is configured to be top-filled.

The container may be a cuboid-shaped unit.

The container may have a floor, a pair of upwardly extending opposed side walls, and a pair of upwardly extending opposed end walls.

The container may be any suitable dimensions and shape.

The container may be a typical shipping container-sized container, such as:

| Container | Internal dimensions (L × W × H) | Cubic capacity |
|---|---|---|
| 1. | 5.89 × 2.35 × 2.36 m | 33 m³ |
| 2. | 5.89 × 2.35 × 2.69 m | 37 m³ |
| 3. | 12.05 × 2.35 × 2.36 m | 66 m³ |
| 4. | 12.05 × 2.35 × 2.69 m | 76 m³ |

The container may be configured to carry any suitable payload.

Typically, the container may be configured to carry a payload of at least 10 tonnes and up to a maximum of 80 tonnes or more, typically 10-80 tonnes, with options of 30-70 tonnes, and 40-60 tonnes.

The container may be made from any suitable material or combination of materials.

By way of example, the container may be made from steel.

The floor, side walls and end walls of the container may be made from or include steel panels that are welded or otherwise connected together to form the container.

The container may include a removable lid that, when positioned, closes the container. In use, the lid may be removed to allow mined material to be loaded therein by excavators and other loading vehicles/devices similar to how open tray trucks are conventionally loaded.

The container may include a lid that can be moved between a closed and an open position while remaining connected to a body of the container.

The container may include a roof and an opening for top-filling the container by excavators and other loading vehicles/devices similar to how open tray trucks are conventionally loaded.

The container may be configured to be tiltable rearwardly to discharge mined material from the container.

The container may be configured to be rotatable about a lengthwise extending axis to discharge mined material from the container.

The container may include an outlet to bottom discharge mined material from the container, typically in the floor of the container.

For example, the floor may include doors that can swing downwardly from a closed position to an open discharge position and then be closed for re-use of the container to receive more mined material.

The container may include container identification, including by way of example, data on the minerology and mass of a payload in the container at a given point in time. The container identification may include QR codes indicative of mineralogy, such as grade, quality (e.g. penalty elements, deleterious material, etc.).

By way of example, the container may be a rotatable container manufactured by Intermodal Solutions Group (ISG), such as described in Australian patent application 2021218002 in the name of Lock and Move Pty Ltd.

Mined material that is economic to process at the time it is mined is described herein as “ore” and mined material that is not economic to process at the time it is mined is described herein as “waste material”.

Mined material as described herein includes material that has been mined and processed to an extent, such as at least primary crushed in a pit of an open cut mine or in an underground mine, as the term “primary crushed” is understood in different sectors (e.g. iron ore, copper, etc) of the mining industry. Typically, primary crushed refers to the first crushing operation on a mined material. The extent of the crushing will vary depending on the type of mined material and the downstream requirements for the material.

Mined material as described herein may be metalliferous or non-metalliferous or metalloid material. Iron-containing and copper-containing ores are examples of metalliferous materials. Coal is an example of a non-metalliferous material.

The term “mine” is understood herein to include an area that is being mined in an open cut mine or an underground mine and stockpiles and size separation plants and mineral processing plants, including comminution units and mineral recovery units associated with the mine.

The mine may be a mine that is in an end of life phase, i.e. moving towards a shutdown.

The invention provides an opportunity to track payloads of mined material and processed mined material having a known mineralogy from a mine pit to a port. This provides an opportunity to minimise material handling, maximise available mined material and processed mined material to meet customer product requirements, minimise material handling to meet customer specifications, and minimise time from a mine pit to a ship. By way of example, the invention provides an opportunity to schedule railway operations from multiple mines to deliver more optimum mined material and processed mined material for meeting customer specifications to a port. The invention provides an opportunity to provide a storage facility for containers of mined material and processed mined material at a port, with container identification and tracking from mine to port and at the port. Therefore, the invention provides an opportunity to minimise rehandling of mined material and processed mined material from a mine pit to a port. Mined material and processed mined material can be loaded into a container and transported in the container and unloaded at a mineral processing plant or at port. This is a significant difference to the current haul truck approach. In addition, the invention provides an opportunity for stockpiling at a port with significantly less dilution, with tracking of the contents of each container, such as mass and composition (Fe, S, Al P, etc). This provides an opportunity for much more deliberate blending to meet customer specifications. In summary, the port opportunities include stockpile precision, material composition, and very deliberate blending of material from different stockpiles to closely match customer specifications.

By way of summary, the invention includes the following features by way of example only and provides the following benefits:
1. Allows for easier change of transport media (e.g. from truck to truck, truck to/from train, stockpile to/from truck).
2. Allows different geared trucks for steep hauls, which provides an opportunity for quicker transport times.
3. Allows use of different transport mechanisms (e.g. a ski lift type haulage) for parts of a journey.
4. Allows for stockpiles (or others) to be built as stacks of containers.
5. Stockpiles can be managed like container ship harbour facility (e.g. using automated straddle carriers, gantries, etc.).
6. Re-handling of mined material and processed mined material (i.e. the transfer of mined material and processed mined material from one transport means to another, or to/from a transport means and a stockpile site) becomes easier with reduced (or outright elimination of) and dilution and loss.
7. Containers can be tracked with the properties (chemical, grade, fragmentation) of their payload over time for example by using RFID/block chain technology.
8. Improved storage of a payload and consequently increased preservation of transported material.
9. Improved resolution (and intelligence) of stockpiles (c.f. trucks with large trays) is achieved due to the fact that load after load of material is not tipped onto stockpiles, which causes blending, mixing, etc.
10. Mined material and processed mined material can be tracked by container load and mapped via a digital twin. This allows for advanced decision making and improved blending into a processing plant (for high and low-grade stockpiles). The resolution is also improved by the use of smaller container sizes (e.g. 50 tonnes vs 200 tonnes), which is a viable option with the invention.
11. Avoids the need for haul trucks with rear-tipping trays and a tipping mechanism and/or hydraulics to unload a transported mined material and processed mined material.

The invention was made as part of a project of the applicant and the inventions that are described and claimed in the following Australian complete applications in the name of the applicant that were filed on 25 Aug. 2021 were made in the course of the project, and the disclosures in the specifications of the applications are incorporated herein by cross-reference:
Australian complete patent application Ser. No. 20/212,21840 titled “Method and apparatus for coordinating loading of haul vehicles”.
Australian complete patent application Ser. No. 20/212,21826 titled “Material categorisation and transportation systems and methods”.
Australian complete patent application Ser. No. 20/212,21812 titled “Methods and systems for mining”.
Australian complete patent application Ser. No. 20/212,21760 titled “Transporting a mined material”.

The inventions made as part of the project are also described and claimed in the following co-pending International applications claiming priority from the above Australian complete applications and the disclosures in the specifications of the International applications are incorporated herein by cross-reference.

International patent application entitled “Method and apparatus for coordinating loading of haul vehicles” having a filing date of 25 Aug. 2022;

International patent application entitled “Material categorisation and transportation systems and methods” having a filing date of 25 Aug. 2022;

International patent application entitled “Methods and systems for mining” having a filing date of 25 Aug. 2022; and

International patent application entitled “A Mining Operation” having a filing date of 25 Aug. 2022.

### BRIEF DESCRIPTION OF THE DRAWINGS

Embodiments of the invention are described further below by way of example only with reference to the accompanying Figures, of which:

FIG. 1 is a schematic view of a typical open cut mine;

FIG. 2 is a schematic view of an open cut mine according to an embodiment of the invention;

FIG. 3 is a perspective view of a container for use in the mine shown in FIG. 2 with the container in a closed configuration;

FIG. 4 is a perspective view of a container for use in the mine shown in FIG. 2 with the container in an open configuration;

FIG. 5 is a schematic view of a “movable unit” in the form of a flatbed truck and the container shown in FIGS. 3 and 4 located on and being transported by the vehicle;

FIG. 6 is a schematic view of a “moving unit” in the form of an overhead suspension system, such as a ski lift type haulage system, and the container shown in FIGS. 3 and 4 suspended from and being transported by the overhead suspension system;

FIG. 7 is a schematic view of a “moving unit” in the form of a train with multiple flatbed rail carriages and a plurality of the container shown in FIGS. 3 and 4 located on the flatbed rail carriages and being transported by the train;

FIG. 8 is a schematic view illustrating a plurality of the container shown in FIGS. 3 and 4 stacked in an intermodal, such as a shipping port-like, storage and handling facility in accordance with an embodiment of the invention; and

FIG. 9 is a top plan view of the intermodal storage and handling facility of FIG. 8.

### DESCRIPTION OF EMBODIMENTS

The invention has particular application to open cut mining iron ore and the description focuses on this application to an extent.

The description mentions other materials, such as copper-containing materials, and processing steps that are relevant to these materials.

The invention is not limited to mining iron ore. The invention extends to mining other materials, such as by way of example only metalliferous materials containing copper, nickel, lithium, aluminium (such as bauxite and alumina), and cobalt, and non-metalliferous materials such as coal, and metalloid materials such as boron (such as borates). The invention also extends to underground mining of materials.

Conventional open pit mining of iron ore comprises progressively drilling and blasting sections of an area to be mined and removing material in those sections from a mine. It is known to mine iron ore in large blocks using a series of benches so that various mining activities can be carried out concurrently in a pit. A bench, which may contain many thousands of tonnes of ore and/or other material is first drilled to form a pattern of “blast” holes. The blasted material is picked up by earth-moving vehicles in the form of front-end loaders and excavators (such as by way of example, electric rope shovels, diesel or electric hydraulic excavators, bucket wheel excavators, dragline excavators) and placed into haulage vehicles such as trucks and transported to a stockpile or to downstream processing plants to produce marketable products to customer specifications.

Downstream processing options in iron ore mines include (a) crushing and screening of mined material to different-sized specifications, such as lump and fines products and (b) more extensive processing in a mineral processing plant that upgrades the mined material. These upgrading processes may be wet or dry processes.

Typically, depending on scheduling requirements, option (a) material is either stored in a stockpile or is transported directly to a railhead (or other transportation option) and then by rail to a port for shipping to a market. Typically, the material is stockpiled at the port and blended with other mined material from the same or other mines and then loaded onto ships that transport the material to markets. Materials handling at ports tends to involve multiple, complex bulk handling steps for mined material.

It is noted that some conventional iron ore open pit mining operations use haul trucks as the only transportation option.

Generally, the sequence of stages of mine→stockpile (coarse ore)→crush/process→stockpile→transport→stockpile→ship in conventional iron ore open pit mining operations are arranged so that each transportation stage “→” uses haul trucks, trains, ships or a mixture of these options.

Typically, operations in a mineral processing plant in option (b) in an iron ore mine (and in mining operations generally, and not confined to iron ore) involve: (i) coarse comminution (crushing and screening); (ii) fine comminution (grinding); and (iii) recovery stages (e.g. flotation, leaching).

The term “comminution as used herein describes processes which reduce the particle size of rocks by, first, crushing (most often in combination with screening or other size separation) and, secondly, grinding (in combination with screening or other size separation).

A recovery stage that applies to a range of mining operations, iron ore, copper-containing material, etc. refers to processes where: (a) valuable minerals are separated from non-valuable material; and/or (b) valuable metal (where metal is a target element) is extracted from the minerals; and/or (c) valuable minerals are separated from other neighbouring valuable minerals. Recovery stage techniques are typically used in combination. A recovery stage technique is usually classified as either wet (using water as a significant part of the process) or dry (largely in the absence of water). Some examples of recovery stage techniques are leaching (wet recovery); flotation (wet recovery); gravity concentration, also referred to as gravity separation (wet recovery); magnetic separation (wet or dry recovery); and particle sorting (dry recovery).

Conventional vehicles for moving mined material include large haul trucks for open cut mines and load, haul, dump (LHD) vehicles for underground mines.

Mined material can also be transported via a conveyor, for example via in-pit crushing and conveying (IPCC) systems.

As noted above, the invention transports mined material within a mine and from a mine using containers that may be readily mounted on and dismounted from “movable units” and “moving units”, with the applicant being interested particularly in “movable units” in the form of RSATs.

The containers may have a form factor that is similar or identical to intermodal containers (i.e. shipping containers). The invention transports mined material within a mine and from a mine in fixed, discrete load units; namely a “container load”. The containers are mountable onto and dismountable from “movable units” and “moving units”, such as RSATs, for transportation within the mine or from the mine. The containers may be (a) unloaded and stacked at designated stockpile locations or (b) discharged directly into comminution units of mineral processing plants or (c) loaded onto other transport options, such as rail transport and taken to other locations such as shipping ports or (d) otherwise processed.

The containers may be any suitable shape and size and construction. For example, the containers may have an openable top, allowing for mined material to be loaded therein by excavators and other loading vehicles/devices similar to how open tray trucks are conventionally loaded.

FIG. 1 shows a schematic view of a typical open cut mine 10 and mining method. The mine 10 comprises a pit 12 that extends below ground level. Inside the pit 12 front end loaders or excavators 14 (or any other suitable earth moving vehicles) dig material that is in the pit 12 after being blasted from benches (not shown) and loads the material into trays of conventional rear-tipping haul trucks 16. The haul trucks 16 transport the mined material from the pit 12 along haul roads 18 to an exit point at ground level. Typically, the haul trucks 16 have rear-tipping trays and are large vehicles capable of transporting large payloads of in excess of 200 tonnes.

At ground level, depending on mine scheduling, the haul trucks 16 transport the material along roads to:
(a) a railway 20 where the material is dumped into rail cars, or
(b) a stockpile where the material is dumped into open-air stockpiles 22.

The haul trucks 16 then travel back to the pit 12 to repeat the cycle.

As required, stockpiled material is loaded onto a conveyor (not shown) or a different haul truck (not shown) and transported from the stockpiles 22 to:
(i) the railway 20 and dumped into rail cars or
(ii) a mineral processing plant (not shown) that includes comminution units and mineral processing units for upgrading the material.

The railway 20 (option (a) or (i)) transports the material to a shipping port 24 where the material can be further processed, for example, blended and then shipped to overseas markets.

Alternatively, the mined material is discharged from the haul trucks 16 at the mineral processing plant and processed in the plant (option (ii)). The haul trucks 16 return to the pit 12. The processed material is transported to the shipping port 24 and can be further processed before being shipped to overseas markets.

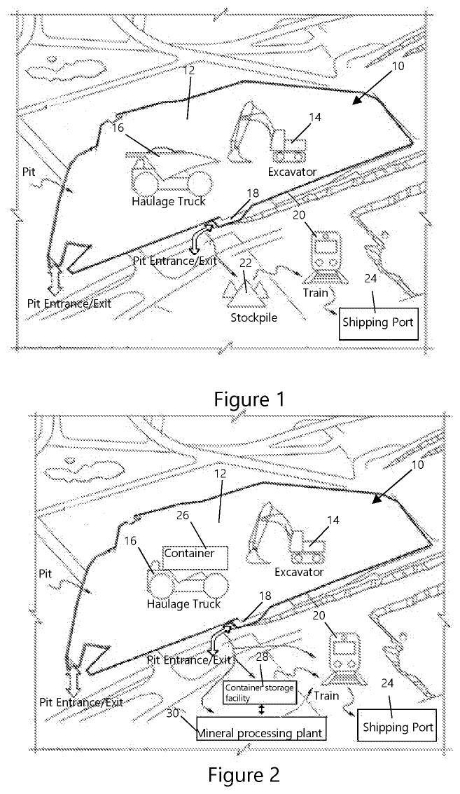

FIG. 2 shows a schematic view of an embodiment of an open cut mine 10 according to the present invention.

The mine of FIG. 2 operates to an extent in the same way as the mine of FIG. 1, where like reference numbers represent the same elements, noting that as well as similarities there are also significant differences between the mines and mining methods in the mines.

The mine and mining method of FIG. 2 differs from the mine and mining method of FIG. 1 in the way in which mined material is transported from the pit 12 and within and from the mine.

With reference to FIG. 2, in the pit 12, mined material is loaded into a container 26 by a loader/excavator/shovel, etc. 14 at a dig face of a blast site and the container is closed once it reaches a payload limit.

The container 26 may be any suitable size.

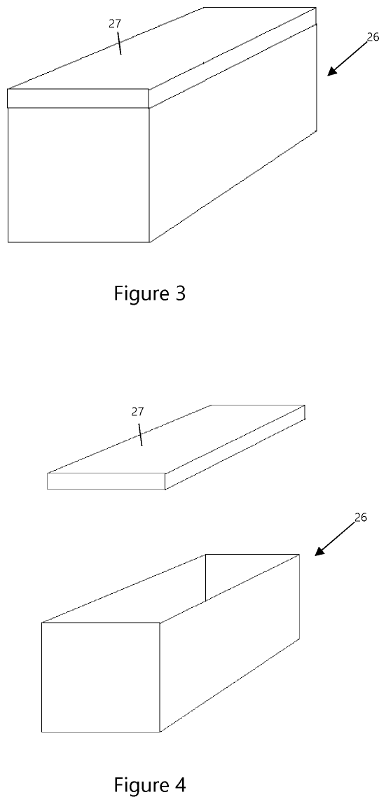

For example, the container 26 may be capable of containing a payload of at least 10 tonnes and up to a maximum of 80 tonnes or more, typically 10-80 tonnes, with options of 30-70 tonnes, and 40-60 tonnes. The payload limit may be reached when the container is full or when it is decided that no more material should go into the container, for example when a change in a grade or certain mineral characteristic of the mined material is detected and it is not desired to have mined material of mixed grades or mineral characteristics in the one container. An embodiment of the container 26 is described below in relation to FIGS. 3 and 4.

The closed container 26 is then carried by a “movable unit”, in this embodiment in the form of a haulage truck 16 configured to support the container 26, for example by providing a haulage truck 16 with a flatbed tray. This is a different vehicle to the haul truck 16 described in relation to FIG. 1.

The haulage truck 16 may have any suitable container mounting, i.e. locating, member.

The haulage truck 16 may include elements to releasably retain (i.e. secure) the container on the container mounting member and consequently on the haulage truck 16.

It is noted that the empty container 26 may have been transported into the pit 12 on the haulage truck 16 or may have been already located in the pit 12 and loaded onto the flatbed tray haulage truck 16 in the pit 12.

The “movable unit” may be a RSAT having a flatbed tray that is configured for carrying a container 26.

The “movable unit” may be any other suitable unit that is configured for carrying a container 26.

The haulage truck 16 transports the container 26 with the material payload along haul roads 18 from the pit 12 to the perimeter of the pit 12 up to an exit point at ground level.

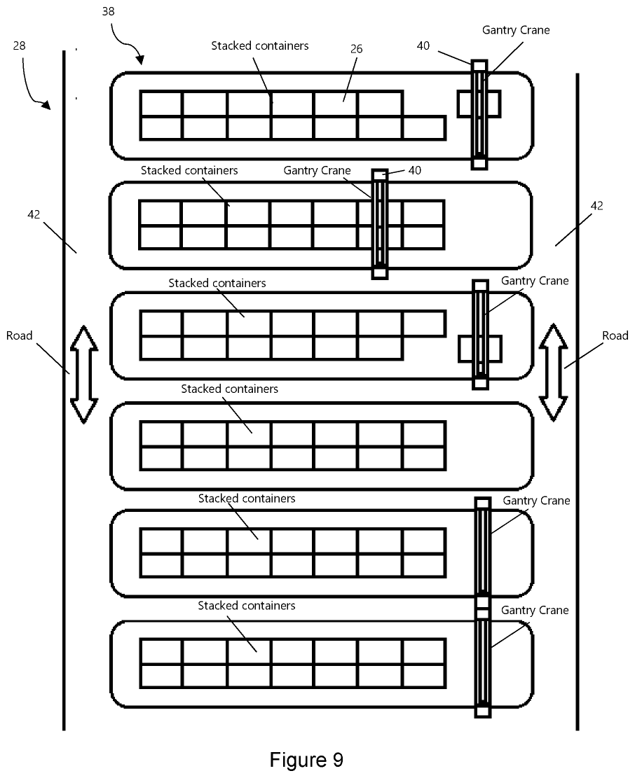

At ground level, one option (indicated by one of the arrows in the Figure) is for the haulage truck 16 to transport the container 26 along roads to a stockpile in the form of a container storage facility 28 where the container 26 with the material in the container is off-loaded from the flatbed tray haulage truck 16 and stored at the facility 28 and the haulage truck 16 picks up an empty container (not shown) from an empty container storage facility (not shown) and returns to the pit 12 to repeat the process. FIGS. 8 and 9 show an embodiment of the container storage facility 28.

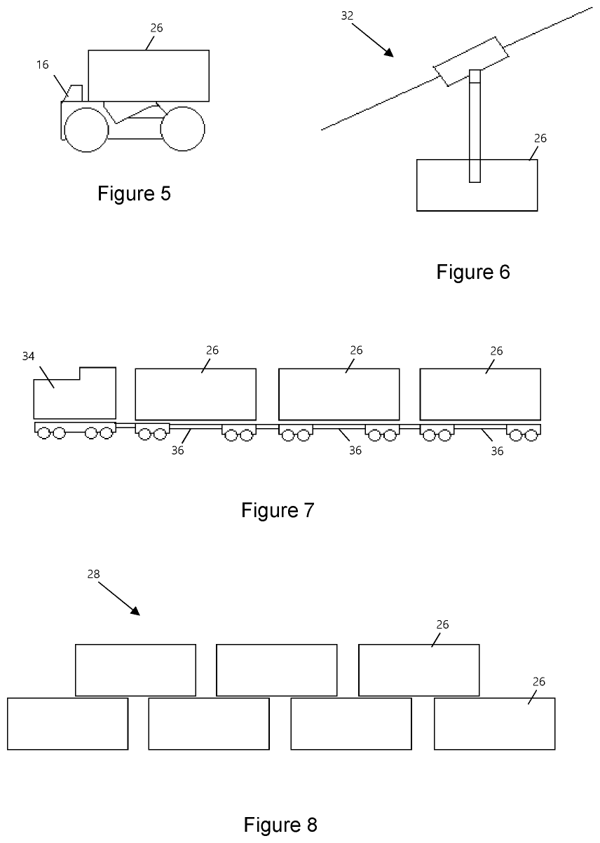

With further reference to FIG. 2, as required by mine scheduling, containers 26 stored at the storage facility 28 are loaded onto other flatbed tray haulage trucks 16 (an embodiment of which is shown in FIG. 5) and are transported to a mineral processing plant 30, at which the mined material in the containers 26 is off-loaded, for example into comminution units at the plant, and thereafter processed through the plant to upgrade the material. The upgraded material is transferred into other containers 26 on flatbed tray haulage trucks 16 and (a) transported to and off-loaded and stored at the container storage facility 28 or (b) transported to and off-loaded onto flatbed railway carriages at a railway 20 and transported on the train to a shipping port 24.

The train with flatbed railway carriages is another embodiment of a “movable unit” in accordance with the invention. FIG. 7 shows an embodiment of the train with flatbed railway carriages.

With further reference to FIG. 2, as required by mine scheduling, loaded containers 26 stored at the storage facility 28 are loaded onto flatbed tray haulage trucks 16 (an embodiment of which is shown in FIG. 5) and are transported to and off-loaded onto flatbed railway carriages at the railway 20 and transported on the train to the shipping port 24.

With further reference to FIG. 2, another option is for the flatbed haulage trucks 16 to bypass the storage facility 28 altogether and transport the material along roads directly to the mineral processing plant 30 and off-load the material in the containers at the plant for processing in the plant.

With further reference to FIG. 2, another option (indicated by one of the arrows in the Figure) is for the flatbed haulage trucks 16 to transport the material along roads to the railway) at which the containers 26 are off-loaded onto railway carriages and are transported on the train to the shipping port 24.

Decisions to select any one of the above options can be made based on a range of factors, including the concentrations of key elements of material in the containers, the total weight of the material, the customer requirements, the available access to the mineral processing plant 30, the storage capacity at the storage facility 28, the storage capacity at shipping port 24, the capacity of blending facilities (not shown) at the shipping port 24, and the availability of material from other mines.

FIGS. 3 and 4 are perspective views of an embodiment of a container 26 with a lid 27 for use in the mine shown in FIG. 2. FIG. 3 shows the container 26 in a closed configuration with the lid 27 closing the container. FIG. 4 shows the container 26 in open configuration with the lid 27 removed from the container. Typically, the container 26 is configured to carry a payload of at least 10 tonnes and up to a maximum of 80 tonnes or more, typically 10-80 tonnes, with options of 30-70 tonnes, and 40-60 tonnes. The container 26 is a cuboid-shaped unit made from steel panels that are welded together, with a floor, a pair of upwardly extending opposed side walls, and a pair of upwardly extending opposed end walls. It is noted that the container 26 shown in FIGS. 3 and 4 is an embodiment amongst many possible embodiments of the container.

FIG. 5 shows an embodiment of the “movable unit” in the form of a conventionally-sized (as described above) flatbed haulage truck 16. The truck 16 may be configured to transport the container 26. The truck 16 may be an electric powered vehicle. One example of a truck 16 is a Right Sized Autonomous Truck (“RSAT”). The truck 16 may be any one or more of autonomously-operated, manually-operated, or semi-autonomously operated. The truck 16 may be a wheel-mounted that can move along a road. The truck 16 includes a retaining element (not shown) to releasably restrain, i.e. secure, the container on the flat-bed tray and consequently to the haulage truck 16. The use of a conventionally-sized flatbed haulage truck 16 makes it possible to construct more conventional roadways rather than those used currently in mines operating with large haul trucks 16 carrying large payloads.

With reference to FIG. 6, instead of a “movable unit” such as the flatbed haul truck 16, other embodiments of the invention operate with a “moving unit” in the form an overhead suspension unit 32, such as a ski-lift type unit, that is configured to support and transport the container 26 along a pathway between a loading location and an unloading location.

FIG. 6 shows the overhead suspension unit 32 located at an incline, for example for the purpose of transporting suspended filled containers 26 out of the pit 12. It is noted that the invention also extends to embodiments where the overhead suspension unit 32 is horizontal.

In use, the containers 26 may be loaded with mined material while the containers 26 are on the ground and then lifted onto the overhead suspension unit 32. Alternatively, mined material may be loaded onto containers 26 while the containers 26 are on the overhead suspension unit 32.

Ski lifts have an advantage that the stored gravitational potential energy of the raised empty containers on the way down the lift can be converted to kinetic energy to assist in movement of the filled containers on the way up the lift. As such, energy can be conserved. In contrast, other than regenerative breaking, no energy is recouped by trucking empty containers down to the pit.

In one example, a ski-lift type arrangement picks up containers at a pit bottom from an RSAT and transports the material to a processing plant, where the material is tipped into a crusher. The empty container is then transported back into the pit and transferred onto the RSAT truck, which itself is driven to a dig face to pick up the next load.

It can be appreciated that in some embodiments, a combination of “movable units” (such as the flatbed haul truck 16) and “moving units” (such as the overhead suspension unit 32) may be used to transport material from the pit 12 and within and from the mine. For example, in these embodiments, the selections of “movable units” and “moving units” may be governed by the transport requirements in the pit 12, from the pit 12, and within and from the mine.

FIG. 7 illustrates a “movable unit” in the form of a train 34 and a series of interconnected flatbed carriages 36 with containers 26 located on the carriages 36.

FIGS. 8 and 9 illustrate an embodiment of the container storage facility 28.

FIG. 8 shows a plurality of the containers 26 stacked at the container storage facility 28.

FIG. 9 shows a layout of the container storage facility 28.

It can be appreciated that the layout is similar to that of a layout at a container shipping port.

The FIG. 9 layout includes:
(a) a plurality of parallel, rectangular container storage sections 38, with stacked containers 26 on the sections;
(b) a gantry crane 40 or any other suitable type of container transportation unit configured to traverse each section 38 and deliver containers 26 to and pick-up containers 26 from the sections;
(c) roadways 42 providing access to the container storage facility 28 and to the sections 38.

The container storage facility 28 includes a container tracking and monitoring system. In an embodiment of the invention, this system is linked to a more extensive tracking and monitoring system that covers movement of containers 26 from the pit 12 through the mine and on the rail transport network and at the shipping port and which includes recording mineralogy data for the material in the containers 26.

In use, a flatbed haulage truck 16 carrying a container 26 filled with material can transport the container into the container storage facility 28, and one of the gantries 40 can pick-up and move the container 26 to a pre-selected location on the associated section 38.

Similarly, as required, the gantry crane 40 can pick-up the container 26 from the stack in the section 38 and load it onto a flatbed haulage truck 16 so that the container can be transported to the mineral processing plant or other location.

It can be appreciated that the above-described embodiment provides considerable flexibility for mine operators and can provide the above-described advantages.

Many modifications may be made to the embodiment of the invention described above without departing from the spirit and scope of the invention.

The embodiment is meant to be illustrative only and is not meant to be limiting to the invention.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment but may be in some appropriate cases. Furthermore, the particular features, structures or characteristics may be combined in any suitable manner, as would be apparent to one of ordinary skill in the art from this disclosure, in one or more embodiments.

In the description provided herein, numerous specific details are set forth. However, it is understood that embodiments of the invention may be practised without these specific details. In other instances, well-known methods, structures and techniques have not been shown in detail in order not to obscure an understanding of this description.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

1. A method of mining in a mine includes:
(a) mining an area in the mine;
(b) loading a mined material in the mining area into a container that is or can be demountably located on a “movable unit” or is or can be demountably coupled to a “moving unit”;
(c) transporting the loaded container from the mining area on the “movable unit” or the “moving unit” to a container storage facility in the mine or a mineral processing plant in the mine; and
(d) removing the loaded container from the “movable unit” or the “moving unit” in the container storage facility and storing the loaded container in the facility; or
(e) removing the loaded container from the “movable unit” or the “moving unit” at the mineral processing plant and processing the material in the plant.

2. The method defined in claim 1 includes loading the stored loaded container at the storage facility onto a “movable unit” or a “moving unit” and transporting the loaded container to (i) the mineral processing plant and discharging the material from the container at the plant and processing the material in the plant or (ii) a railhead or other transport terminal and transferring the container from the “movable unit” or the “moving unit” onto flatbed rail carriages and transporting the container to another location, such as a port.

3. The method defined in claim 1 includes transporting the loaded container on the “movable unit” or the “moving unit” from the mining area to a mineral processing plant and discharging the mined material from the loaded container at the plant and processing the material in the plant.

4. (canceled)

5. The method defined in claim 1 wherein the mined material includes as-mined material.

6. (canceled)

7. (canceled)

8. An engineered stockpile for storing mined material or processed mined material in a mine, the stockpile comprising a plurality of containers each containing a volume of mined material or processed mined material and a tracking identifier for each container, the tracking identifier associated with a digital record identifying a location of the container and one or more properties of the material in the container.

9. The stockpile defined in claim 8 includes a retrieval system for identifying where in the stockpile a specified container is located and retrieving the specified container from its location.

10. The stockpile defined in claim 8 wherein one or more properties includes a grade of the mined material, a mineralogy of the mined material such as an average particle size or a chemical composition of the mined material in the container.

11. The stockpile defined in claim 8 wherein the containers include container identification, including data on the minerology and mass of a payload in the container at a given point in time.

12. A mine includes:
(a) an area to be mined or being mined in the mine; and
(b) a storage facility for containers of mined material transported from the mine area, the containers being configured to be demountably located on a “movable unit” or demountably coupled to a “moving unit”.

13. The mine defined in claim 12 wherein the container storage facility includes “carrier units” for moving and locating containers in selected locations and for retrieving the containers from the locations, when required.

14. The mine defined in claim 12 includes a container tracking system for tracking movement of containers within and from the mine and at downstream locations such as a shipping terminal or a customer location.

15. The mine defined in claim 14 wherein the container tracking system is configured to track the location of a container in the container storage facility.

16. The mine defined in claim 14 includes a mine planning and scheduling system that is responsive to information in the container tracking system, operating capabilities and availability of equipment in the mine, transportation scheduling within and from the mine, customer requirements for mineralogy of mined material, and scheduling and processing equipment capability/availability in a port or other product shipping terminal.

17. The mine defined in claim 16 wherein the mine planning and scheduling system is configured to adjust operations within the mine or in transporting material from the mine or at a port or other shipping terminal to optimise production and shipping to customers.

18. The mine defined claim 12 wherein the containers include container identification, including data on the minerology and mass of a payload in the container at a given point in time.

19. The mine defined in claim 12 wherein the “movable unit” includes an autonomous, movable vehicle that is configured to receive and support the container while the container holds a payload of material.

20. The mine defined in claim 12 wherein the “moving unit” includes an overhead suspension unit that is configured to support and transport the container along a pathway between a loading location and an unloading location.

21. (canceled)
